(19) United States
(12) Patent Application Publication
(10) Pub. No.: US 2020/0143360 A1
(43) Pub. Date: May 7, 2020

(54) SYSTEMS AND METHODS FOR GIFTING OF PRODUCTS, STORED VALUE INSTRUMENTS, OR BOTH

(71) Applicant: GroupGifting.com, Inc., Huntington, NY (US)

(72) Inventors: Eric Charles Manno, Centereach, NY (US); David Scott Levinsky, Huntington Station, NY (US); Tyler Roye, Huntington, NY (US); Mark James Manno, Dix Hills, NY (US)

(21) Appl. No.: 16/416,660

(22) Filed: May 20, 2019

Related U.S. Application Data
(63) Continuation of application No. 15/089,833, filed on Apr. 4, 2016, now abandoned.
Application No. 15/089,833 is a continuation of application No. PCT/US14/59377, filed on Oct. 6, 2014.
(60) Provisional application No. 61/887,330, filed on Oct. 4, 2013.

(51) Int. Cl. G06Q 20/34; H04L 12/58; G06Q 50/00; G06Q 30/06; G06Q 20/12; G06Q 20/28; G06Q 30/00

(52) U.S. Cl. CPC G06Q 20/342; H04L 51/36; G06Q 50/01; G06Q 30/01; G06Q 20/12; G06Q 20/28; G06Q 30/0631

(57) ABSTRACT

The gifting systems and corresponding methods of the present disclosure electronically provide a stored value instrument as a gift in place of a suggested product. The methods include taking a selected product offered for sale on a merchant's eCommerce website, converting that product into a gift suggestion, and delivering a personalized message including the gift suggestion and the stored value instrument to a gift recipient, based on various calculations, rules, and user inputs. The gift recipient can either purchase the suggested gift or any other gift from the eCommerce website's merchant using the stored value instrument. These systems and methods support multiple contributors to the gift and can be used via social or non-social networks. These systems and methods also support the delivery of personalized online messages related to a gift via social networks, email, or SMS. The personalized online messages include eGreeting cards, written messages, video recordings, and/or photos.

### BACKGROUND

### 1. Technical Field

The present disclosure relates to systems and methods for providing stored value instruments as gifts via eCommerce systems and/or social networks, and, more particularly, for enabling a gift organizer to suggest a product as a gift and sending the gift suggestion and the stored value instrument to the gift recipient in place of the product.

### 2. Background of Related Art

Social commerce is growing rapidly due to the growth of social networks and eCommerce systems designed to work in conjunction with social networks. People exchange gifts for a variety of events or occasions. Choosing the right gift is often a challenging task because of the unique needs and wants of a gift recipient along with the many choices offered from a multitude of merchants via eCommerce websites.

The act of gift giving is further complicated when more than one participant contributes to a gift. Typically, the burden of choosing the gift, collecting funds from contributors, having those contributors sign a greeting card, and delivering the gift to a recipient is on the shoulders of the gift organizer.

In many cases, a gift recipient receives a gift that they really do not want. This results in returned or exchanged products, which has an impact on the cost to merchants, imposes an inconvenience on the gift recipient, and results in an overall poor gifting experience for all parties involved.

Giving gift cards as an alternative to a physical gift is an accepted practice and, in many cases, is preferred by gift recipients. There are many systems for purchasing and sending electronic gift cards and physical gifts via eCommerce websites, either as an individual or as a group.

### SUMMARY

The present disclosure features a system that allows for the creation of a gift based on a product selected by gift organizers from an eCommerce website. Gift organizers can use the system as a tool to collect funds to be applied toward a stored value instrument, e.g., as a group gift, and to deliver the stored value instrument and personalized messages, videos, and photos from some or all gift participants to a gift recipient.

The present disclosure also features a gifting system that converts attributes about a product selected from an eCommerce website into a gift idea. Gift organizers can use the system as a tool to collect funds toward a product as a group gift and to deliver personalized messages, videos, and photos from all gift participants along with a notification of the gift idea and a stored value instrument that can be used by a gift recipient to purchase the selected product or any other product from a eCommerce website merchant.

The present disclosure further features a gifting system that can deliver notifications to a recipient of a stored value instrument that can be used to purchase a product and deliver personalized messages, videos, and photos from all gift participants. Since the system gives the gift recipient a stored value instrument instead of a physical product as a gift, the entire gifting experience is improved for those organizing a gift, those contributing to the gift and, most importantly, those receiving a gift.

In one aspect, the gifting system may be used to facilitate a group gift based on a given product that is selected from a merchant's product catalog published on an eCommerce website. A group gift is a gift that involves participation, either monetary or non-monetary, by more than one person.

In another aspect, the gifting system can be used to facilitate a social gift based on a product that is selected from a merchant's product catalog published on an eCommerce website. A social gift is a gift that involves participation, either monetary or non-monetary, by at least one person via a social network.

The gifting system takes the selected gift displayed on a merchant's eCommerce website and based on various calculations, business rules and user input, makes a determination to deliver the gift to the recipient as a stored value instrument. For example, a stored value instrument could be a gift card, a gift certificate, or a store credit, any of which can then be used by the gift recipient to purchase the originally suggested product or any other product available from the merchant. The gift notification includes a link that allows the gift recipient to claim the stored value instrument, along with personal messages, videos, and photos from the participants, which are delivered to the recipient along with the gift via social networks, email, short message service (SMS), etc.

The present disclosure features a method for electronically providing a stored value instrument in place of a suggested product as a gift. The method includes receiving from at least a first electronic device associated with a first user a request to suggest a product, which is defined by data stored in an eCommerce server, as a gift for a second user associated with at least a second electronic device, obtaining data of the product from the eCommerce server; authenticating the first user of the at least the first electronic device, determining a contribution amount; receiving funds from the first user to be applied towards the contribution amount, determining whether a predetermined condition has been met; and sending a message to the second user including the data of product suggested as a gift to the second user and a stored value instrument to the second user, if the predetermined condition has been met.

The method further includes displaying a screen on the at least the first electronic device prompting the first user to invite at least a third user associated with at least a third electronic device to contribute towards the cost of the product, sending an invitation message to the at least the third electronic device, the invitation message including a link to view the product, a setting of the contribution amount, and a personalized message field, and receiving funds from the at least a third user to be applied towards the contribution amount. In an aspect, the invitation message is sent to the at least a third user via a social network, an email, or an SMS message.

The method still further includes prompting the first user to manually set a contribution amount or automatically calculating contribution amounts. In an aspect, the stored value instrument is selected from a group consisting of a gift card, a gift certificate, a store credit, an online credit, an offline credit, a coupon, and any combinations thereof.

The method still further includes receiving a claim for the stored value instrument from the at least a second electronic device associated with a second user, and receiving a message from the at least a second electronic device to be provided to at least the first user. In an aspect, determining whether the predetermined condition is met includes at least one of determining whether a predetermined period has elapsed and determining whether a total contribution amount is greater than or equal to the target contribution amount. In another aspect, the at least a third user includes a plurality of users, wherein determining whether a predetermined condition is met includes determining whether the first user and the plurality of users have all contributed funds towards the contribution amount.

The method still further includes determining the gift type, converting the contributed funds to a stored value instrument if it is determined that the gift type is a stored value instrument, and sending a message to order the product if it is determined that the gift type is a physical product.

The method still further includes determining whether a total contribution amount is greater than the cost of the product to determine whether there are additional funds, and converting the additional funds to a stored value instrument if it is determined that the total contribution amount is greater than the cost of the product.

In an aspect, the obtained data regarding the product is selected from the group consisting of a price, a tax, a shipping cost, a description, an image of the product, and any combinations thereof.

In another aspect, obtaining data of the product from the eCommerce server includes dynamically analyzing a webpage of the eCommerce server to obtain data regarding the product.

In embodiments, the present disclosure also features a gifting system for electronically providing a stored value instrument in place of a suggested product as a gift. The gifting system includes a processor and a memory storing processor-executable instructions that, when executed by the processor, cause the gifting system to receive from at least a first electronic device associated with a first user a request to suggest a product, which is defined by data stored in an eCommerce server, as a gift for a second user associated with at least a second electronic device, obtain data of the product from the eCommerce server, authenticate the first user of the at least the first electronic device, determine a contribution amount, receive funds from the first user to be applied towards the contribution amount, determine whether a predetermined condition has been met, and send a message to the second user including the data of product suggested as a gift to the second user and a stored value instrument to the second user, if the predetermined condition has been met.

The present disclosure also features a system including a page analyzer and a gifting engine. The page analyzer gathers attributes about a product selected by an organizer as a gift from an eCommerce website server. The gifting engine configured to create a screen to present the selected product as a suggested gift based on the product attributes gathered by the page analyzer, and to convert the selected product to a stored value instrument when a predetermined condition is met. The system may further include an interface coupled to the gifting engine. The interface retrieves data about the product from a plurality of external data sources and transfers the data about the product to the gifting engine. The gifting engine may create the screen presenting the selected product as a suggested gift based on the data about the product.

### BRIEF DESCRIPTION OF THE DRAWINGS

A complete understanding of the present disclosure may be obtained by reference to the accompanying drawings, when considered in conjunction with the subsequent, detailed description, in which:

FIG. 1 is a diagram of a group of user types that interact with a gifting system in accordance with various aspects of the present disclosure;

FIG. 2 is a schematic diagram of a communication network for a gifting system in accordance with various aspects of the present disclosure;

FIG. 3 is a schematic diagram of a gifting system illustrating exchanges of data in accordance with various aspects of the present disclosure;

FIG. 4 is a block diagram of a computer device used for implementing various aspects of the present disclosure;

FIG. 5 is a flowchart of a method of gifting in accordance with aspects of the present disclosure;

FIG. 6 is a flowchart of a method of obtaining contributions from contributors in accordance with aspects of the present disclosure;

FIG. 7 is a flowchart of a method of providing a stored value instrument as a gift to a gift recipient in accordance with aspects of the present disclosure; and

FIGS. 8 and 9 are flowcharts illustrating methods in accordance with other aspects of the present disclosure.

### DETAILED DESCRIPTION

Today there is no effective way to start a gift, including a group gift, based on a product that is listed in a catalog of an eCommerce system. More importantly, there is no way to offer the merchant, gift organizer, or recipient the option of issuing a stored value instrument as an alternative to a physical product. Additionally, as it relates to the collection of funds for a group gift for a physical product, there is no effective way to deal with the challenges associated with collecting funds greater than or less than the total cost of the physical product.

The gifting system of the present disclosure allows for creation of a gift, such as a group gift or a social gift, based on a product selected from an eCommerce website. The gifting system converts attributes about the product selected from the eCommerce website into a gift idea or a gift suggestion. Gift organizers can use the system as a tool to collect funds toward a group gift and to deliver personalized messages, videos, and photos from all gift participants along with a notification of the gift idea and a stored value instrument that can be used by a gift recipient to purchase the selected product or any other product from an eCommerce website merchant. The gifting system can deliver notifications to a gift recipient of either a physical gift, a stored value instrument that can be used to purchase a product, or both the physical gift and the stored value instrument.

According to a gifting method of the present disclosure, a gift organizer visits an eCommerce website and chooses to start a gift, such as a group gift or a social gift, based on a displayed product. First, the gift organizer selects the product and the gifting system imports all relevant information about the product, including a description of the product, its cost, and other information associated with the product.

Next, the gift organizer logs in to the gifting system using, for example, a social log in, such as a login for Facebook, or a non-social log in, using a user ID and password.

The system converts the imported product data and presents a web page that displays the selected product and, in some aspects, a description of the stored value instrument.

Next, the gift organizer chooses a gift recipient, which can be selected from a list of friends within their social network or by manually inputting a name and/or email address.

The system then offers an opportunity to suggest a product as a gift. The system may optionally offer the organizer the opportunity to invite contributors, making it a group gift. As contributors are invited, the system may automatically calculate recommended contributions based on the converted value of the originally suggested product. Alternatively, recommended contribution amounts can be manually entered by the gift organizers or ignored.

The gift organizer may then personalize the gift by adding a personal message, a video, and/or a photo.

The system then presents delivery options that can be set by the gift organizer. These delivery options could include but are not limited to delivery date, delivery time, and delivery method, and type of gift, which could be either a physical gift or a stored value instrument. The type of gift could be preset by the merchant as either a physical gift or a stored value instrument, in which case the gift organizer would not be presented with the option to choose between the physical gift and the stored value instrument.

Next, the gift organizer may make a payment using a credit card, PayPal, Bitcoin, or other payment method, at which point the gifting system converts the payment and updates the gift value, sends invitations to contributors, if applicable, and provides a confirmation that the process completed successfully.

Gift contributors can receive notification of the gift via social networks, email, and SMS. The notification may contain a link that directs the contributor to a view of the gift. If the invited contributor chooses to participate in the group gift, they can first login to the system using a social or non-social login. Then, they can add their contribution amount based on the recommended contribution or by entering any other amount.

Next the gift contributor can personalize the gift with their own written message, video recording, and/or photo.

To complete the contribution process, a gift contributor can make a payment using an approved payment method and the gifting system can convert the payment and apply it to the total gift value. The gifting system can also send out any applicable notifications and provide the contributor with a confirmation that the process completed successfully.

When it is time to deliver the gift, the gift recipient receives notification via social networks, email, or SMS that the gift recipient has been given a stored value instrument as a gift. The notification can include a link to the store value instrument. When the recipient clicks the link to view the link, they can receive a prompt to first login to the system using a social or non-social login. Once logged in, the gift recipient can view all of the messages, videos, and photos sent with the stored value instrument. The gift recipient may be presented with a message indicating the gift idea and can claim the stored value instrument. When the stored value instrument is claimed, the gift recipient may be presented with a unique stored value code, for example, a gift card number and pin number.

In cases where a physical gift is sent, the gift recipient may be able to view all of the messages, videos, and/or photos. Additionally, in cases where a physical product is sent as a gift and the amount of funds collected are greater than the cost of the physical gift, the recipient may receive both the physical product and the stored value instrument, where the value of the stored value instrument is equal to the difference between the cost of the product and the total amount of collected funds.

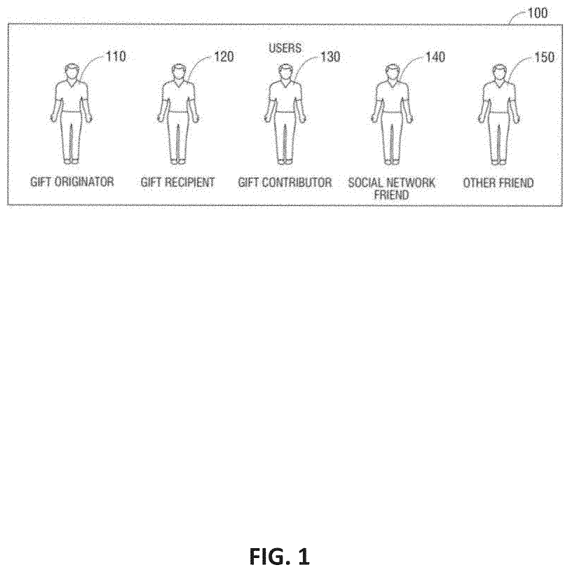

FIG. 1 is a diagram of a group of user types 100 that interact with gifting systems and that are participants in a gift in accordance with various aspects of the present disclosure. User types include gift organizer 110, gift recipient 120, gift contributor 130, social network friend 140, and other friend 150. Gift organizer 110 creates and sends a gift to the gift recipient 120. The gift organizer 110 and the gift recipient 120 may be members of a social network. Gift contributor 130 contributes to the gift created by the gift organizer 110 may also be a member of a social network. Social network friend 140 may be friends of any of the other users 100 when they are members of the same social network. Other friend 150 is one who has a relationship with a group of user types 100 but who is not connected via any social networks.

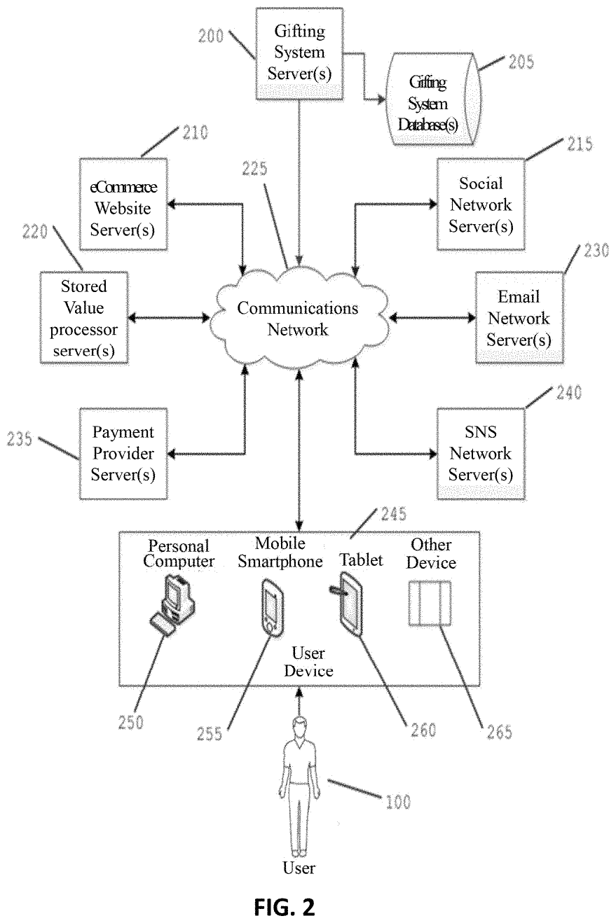

FIG. 2 is a schematic diagram of a communication network for connecting social network server(s) 215, email network server(s) 230, SMS network server(s) 240, payment provider server(s) 235, stored value processing server(s) 220, eCommerce website server(s) 210, users 100, and a gifting system server(s) 200 in accordance with the present disclosure.

The gifting system server 200 includes a gifting system which is an application executed by a central processing unit and random access memory (RAM) of a computer device. The gifting system is used for facilitating the organization, management, and delivery of social or group gifts as a stored value instrument based on products selected from a product catalog of the eCommerce website server 210. The gifting system database 205 is used by the gifting system server 200 to store data about products, users, gifts, and configuration data necessary for the creation, management, and delivery of gifts including group gifts. The gifting server 200 may be connected to the gifting system database 205 over a local network or within the cloud. Data stored in the gifting system database 205 can be added, modified, or deleted by the gifting system server 200.

The eCommerce website server 210 is a third party server that hosts eCommerce websites for companies that sell products over a digital network and provides product information to the gifting system server 200. The gifting system server 200 communicates with eCommerce website server 210, extracts product information from product catalogs to create social or group gifts, and then, in some circumstances, may place orders within a shopping cart of the eCommerce systems to complete the purchase and delivery of a social or group gift.

The communications between the servers and users 100 identified in FIG. 2 may take place over a communications network 225. The communications network 225 can be a public or private network. For example, the communications network 225 could be the Internet or a private point-to-point network.

To identify gift recipient 120 and/or invite the gift contributor 130 to participate in group gifts, the gifting system server 200 may communicate with the social network server 215, which is a third party server that is used by the gifting system server 200 to gather social information regarding friends of the gift organizer 110, the gift contributor 130, and the gift recipient 120. The social information may be used to facilitate the selection of the user types 100 and to deliver messages regarding gifts via the communications network 225 using application program interfaces. For example, a social network may be FACEBOOK®, TWITTER®, PINTEREST® or any other type of community-based application that facilitates interactions between its users.

The stored value processor server 220 is a third party server that is used to generate and maintain unique codes for various types of closed loop financial instruments. For example, these financial instruments may include gift cards, gift certificates, store credits, online credits, offline credits, coupons, or any other type of financial instrument that has a monetary value associated with it. The gifting system server 200 communicates with the stored value processor server 220 to facilitate the delivery of social or group gifts as gift cards, gift certificates, or any other type of stored value instrument.

Email network server 230 is used by the gifting system server 200 to send and receive email communications to users for the purpose of system notifications including invitations to participate in gifts, receipts of gifts, automated confirmations of orders, and gift status updates. Payment provider server 235 is used by the gifting system server 200 to facilitate payments toward social or group gifts. For example, payment types may include open loop credit cards, such as VISA®, MASTERCARD®, AMERICAN EXPRESS®, Discover, PAYPAL®, BITCOIN®, and any other type of payment method.

In addition to the email network server 230, the gifting system server 200 can also communicate with users via the SMS network server 240, which may be used by the gifting system server 200 to send and receive email communications to users for the purpose of system notifications including invitations to participate in gifts, notifications of receipt of gifts, and automated confirmations of orders or gift status updates.

Users may access the gifting system server 200, the social network server 230, the eCommerce website server 210, the email network server 230, and the SMS network server 240 via various user devices 245 including a computer 250, mobile smartphone 255, tablet 260, or other electronic device 265 available today or in the future.

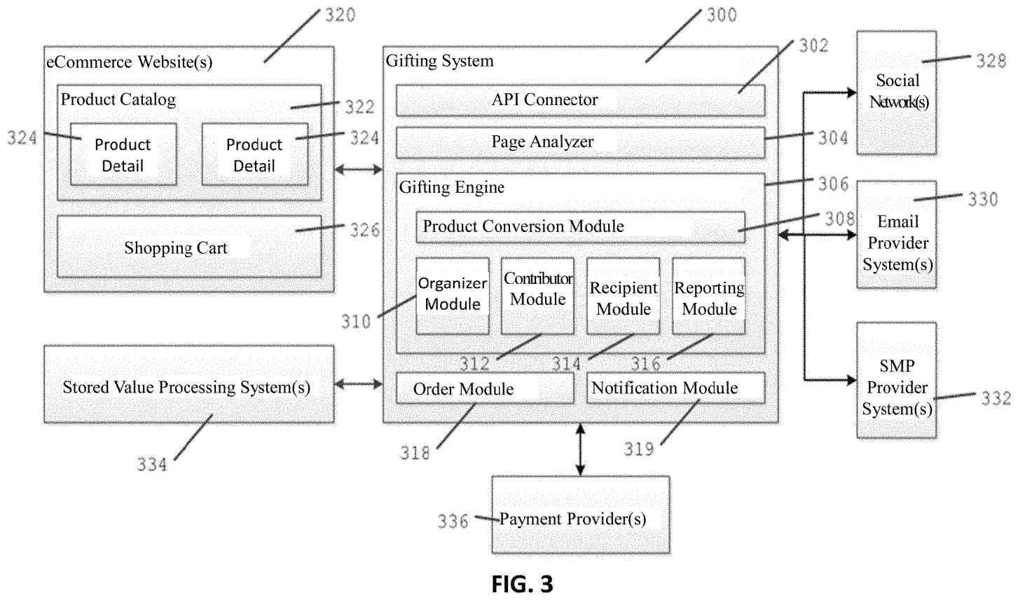

FIG. 3 is a block diagram of a gifting system 300 illustrating exchange of data between an eCommerce website 320, the gifting system 300, a stored value processing system 334, a social network 328, an email provider system 330, and a SMS provider system 332 in accordance with the present disclosure. This block diagram shows components of the gifting system 300 and the transfer of data between the eCommerce website 320, the social network 328, the email provider system 330, the SMS provider system 332, and the stored value processing system 334 used for creation, management, and delivery of social and group gifts.

In one embodiment, to start a social or group gift based on a product listed on an eCommerce website, the gift organizer 110 visits the ecommerce website 320, views a product catalog 322, and select a product to view the product detail 324. Gift organizer 110 can also start a social or group gift for a product from a gift registry, eCommerce shopping cart 326, or any other electronic page that contains information regarding a product for sale.

Once the gift organizer 110 has decided what product for which she would like to start a social or group gift, the gift organizer 110 clicks a button or selects a link to a page analyzer 304 of the gifting system 300 from the eCommerce website 320 that initiates the gifting system 300.

The page analyzer 304 gathers information about the selected product from the eCommerce website 320. The information about the selected product may include price, description, and its associated image. The eCommerce website 320 may provide product information in a form specific for the eCommerce website 320. In other words, other eCommerce websites may provide product information in a form different from that of the eCommerce website 320. In this respect, the page analyzer 304 may dynamically gather product information regardless of the form or configuration of different eCommerce websites and the platforms on which they are built.

In some cases, an API connector 302 may be initiated to gather additional product attributes from the eCommerce website 320 or to send information to the eCommerce website 320 about the social or group gift. The additional information gathered by the API connector 302 may include tax, shipping costs, representative image, descriptions, or any other information related to the product. The aforementioned information sent to the eCommerce website 320 by the API connector 302 may include gift identification or user information.

When the page analyzer 304 and the API connector 302 gather and send the product attributes to the gifting system 300. The attributes are passed to the product conversion module 308, which converts the attributes to gift data and stores the gift data in the gifting system database 205 as a unit of measure which will be used to set a target value for the gift.

The product conversion module 308 resides in the gifting engine 306, which maintains preset business rules that define how a social or group gift for a product can be fulfilled when it is time to deliver the gift to the gift recipient 120. Attributes related to the preset business rules are stored by the gifting engine 306 in the gifting system database 205. Fulfillment methods may include delivery of the physical product and delivery of a stored value instrument. In one aspect, a stored value instrument may be delivered to the gift recipient 120. The business rules can be set by the owner of the eCommerce website 320 and, in some cases, they can be modified by the gift organizer 110 or the gift recipient 120.

The gifting engine 306 also includes the organizer module 310, which receives the converted product attributes from the product conversion module 308 and presents them to the gift organizer 110.

The organizer module 310 is connected via API connections to social network 328 to allow the gift organizer 110 to log in to the gifting system 300. However the gift organizer 110 does not have to be part of a social network to log in to the gifting system 300. Instead, the gift organizer 110 may access the gifting system 300 with a non-social login or a single sign on method used between the gifting system 300 and the eCommerce website 320.

The organizer module connection to social network 328 is also used for selection of the gift recipient 120. However, the gift recipient 120 does not have to be a member of a social network. Instead, the gift recipient 120 may be identified with the entry of general contact information that may include, but that is not limited to, first name, last name, and email address.

The organizer module 310 is also used to invite others to participate in a group gift. Once again, the organizer module 310 connects with the social network 328 to view a list of friends of the gift organizer 110, who can be invited to participate as the gift contributor 130. However, the gift contributor 130 does not have to be a part of social network 328 and may be invited via an email or SMS message.

The organizer module 310 is used to notify the invited gift contributors 130 that they have been invited to participate in a group gift by passing data to the social network 328, the email provider systems 330, and the SMS provider systems 332 via the notification module 319. Attributes related to the invited gift contributors 130 are stored by the gifting engine 306 in the gifting system databases 205.

The organizer module 310 is also used to personalize the gift with the addition of electronic greeting cards, written messages, video, photo images, or any combination thereof. Attributes related to gift personalization are stored by the gifting engine 306 in the gifting system database 205.

The organizer module 310 is also used to allow the gift organizer 110 to set gift delivery options, which may include date and time of delivery, public or private notification of the gift, and how the gift will be delivered. Delivery options are stored in the gifting engine 306 and in certain cases may override any preset business rules.

The organizer module 310 is also used to allow the gift organizer 110 to make a payment toward the gift. Payments are sent to the payment provider 336 and, upon receipt of the payment confirmation from the payment provider 336, the organizer module 310 will generate a confirmation web page and send an order confirmation via the email provider system 330 to the gift organizer 110. The organizer module 310 will then pass payment attributes to the product conversion module 308 for comparison purposes against the target gift amount and to track the total gift amount. The organizer module 310 may also send information via API connection to the social network 328 regarding use of the gifting system 300.

The contributor module 312 resides in the gifting engine 306. The contributor module 312 is used by the gift contributor 130 to participate in a group gift by allowing them to personalize the gift and to make contributions to the gift. The contributor module 312 is connected to product conversion module 308 to track contributions made by gift contributor 130 where they are applied to the total gift value and compared against the price of the target gift.

As with the organizer module 310, the contributor module 312 is also connected to the social network 328, the email provider system 330, the SMS provider system 332 to facilitate log in to the gifting system 300 and to the notification module 319 to send communications between the gifting system 300 and the contributors. However, the gift contributors may not be required to use a social log in.

The recipient module 314 resides within the gifting engine 306. The recipient module 314 interfaces with the notification module 319 to control delivery notification of the gift to the gift recipient 120 and to communicate with the social network 328, the email provider system 330, and the SMS provider system 332 to send communications to the gift organizer 110 and the gift contributor 130. The recipient module 314 connects to social network 328 to allow the gift recipient 120 to log in to the gifting system 300. However, as with the organizer module 310 and the contributor module 312, a social log in may not be required.

The recipient module 314 interfaces with the product conversion module 308 to present suggested gift attributes and the actual gift value that has been collected from the gift organizer 110 and the gift contributor 130 to the gift recipient 120. The recipient module 314 can, in some cases, offer the gift recipient 120 options on how they would like their gift delivered.

The order module 318 resides in the gifting engine 306 and connects with the recipient module 314 and the product conversion module 308 to place orders for physical products, stored value instruments or both when the gift recipient 120 claims the gift. In cases of an order for a physical product, the order module 318 passes product order attributes that may include product stock-keeping unit (SKU), quantity and payment information, through the API connector 302 to a shopping cart 326 at the eCommerce website 320. In cases of an order for a stored value instrument, the order module 318 interfaces with a stored value processing system 334. The stored value processing system 334 is a third party system that facilitates the delivery of social or group gifts as gift cards, gift certificates, or any other type of stored value instrument.

Methods of connection between the order module 318 and the stored value processing system 334 are typically via an API connection. However, in some circumstances, other means of connection may be used.

The reporting module 316 resides within the gifting engine 306 and interfaces with all components of the gifting system 300. The reporting module 316 provides reports to user that may include information about a gift amount, claim status, or delivery status. The reporting module 316 may also provide reports to ecommerce website 320 owners regarding gift sales data and user demographic data collected from the social network 328 when available. The reporting module 316 may also provide reports to system managers regarding the overall health and performance of the gifting system 300.

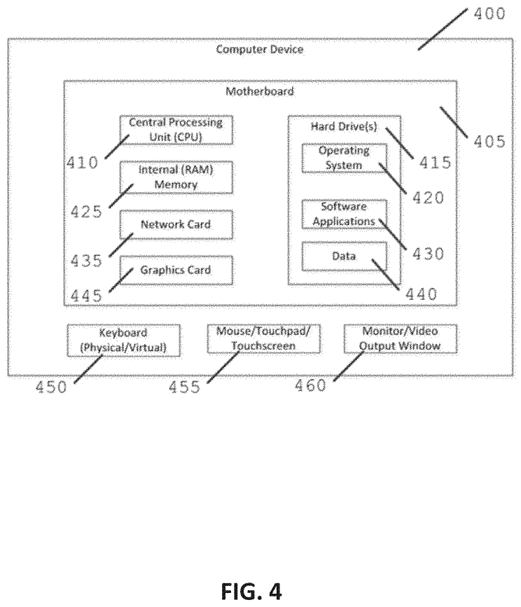

FIG. 4 is a block diagram of a computer device 400 used for implementing various aspects of the present disclosure. A computer device 400 can be a user device or a server. The computer device 400 consists of multiple components. The motherboard 405 is used for connecting all of the internal components of the computer device 400. The central processing unit 410 is used for processing commands from computer programs. The hard drive 415 is used for the storage of programs in the form of an operating system 420 and software applications 430 and for the storage of data 440. The internal random access memory (RAM) 425 is used for the temporary storage of various types of information, making that information available for quick access and temporary use. The network card 435 connects the computer device 400 to a communications network 225. The graphics card 445 provides users 100 with a graphical user interface via a monitor/video output display.

The computer device 400 is accessed by users via a keyboard 450, which can be physical or virtual and in certain cases via a mouse/touchpad/touchscreen 455. The present disclosure operates as a software application 430 on a computer device 400. The gifting system 300 and all of its modules, including the API connector 302, the page analyzer 304, the gifting engine 306, the product conversion module 308, the organizer module 310, the contributor module 312, the recipient module 314, the reporting module 316, the order module 318, and the notification module 319, all may be implemented by a series of commands written in a computer language that are executed by the central processing unit 410 of the computer device 400.

The gifting system 300 and all input and output data 440 are stored on the hard drive 415. At times, the gifting system 300 will access the internal RAM 425 for the temporary storage of the data 440 or the rapid execution of a series of commands. Data 440 from the social network 328, the eCommerce website 320, the email provider system 330, the SMS provider system 332, the stored value processing system 334, the payment provider 336, and the internal or other external data sources is accessed via the communications network 225 through the network card 435. Additionally the data 440 is delivered over the communications network 225 to the social network 328, the ecommerce website 320, the email provider system 330, the SMS provider system 332, the stored value processing system 334, the payment provider 336, and the internal or other external data sources via the network card 435.

The keyboard 450, which can be physical or virtual, and the mouse/touchpad/touchscreen 455 are used for manual data entry to the gifting system 300 via the organizer module 310, the contributor module 312, the recipient module 314, and the reporting module 316 via input data forms that are delivered via a graphical user interface that is shown on a monitor/video output window 460 via the graphics card 445.

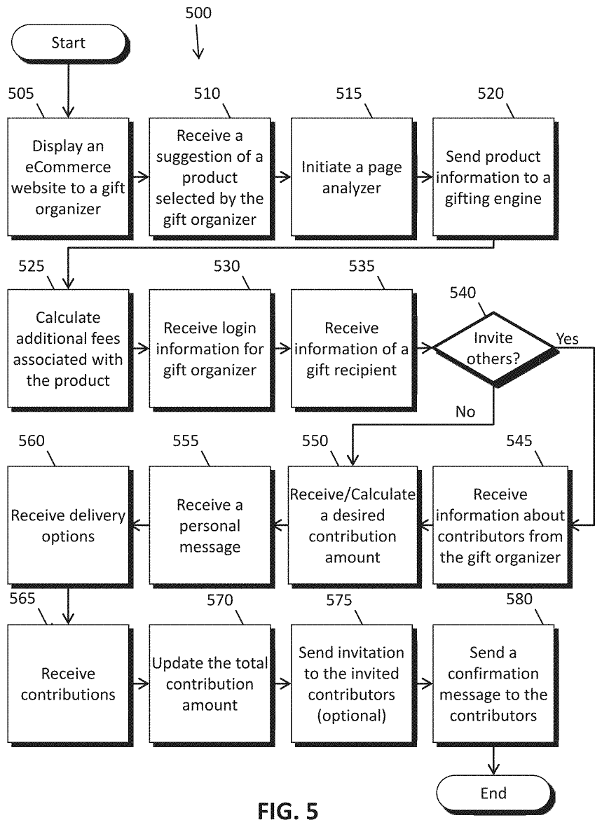

FIG. 5 is a flowchart of a method 500 illustrating how a user acting as a gift organizer selects a product from an eCommerce website to give as a gift or as a gift suggestion, chooses a gift recipient, optionally invites a gift contributor, personalizes the gift, and contributes to the gift. The gifting engine 306 stores data 440 about the product, the product conversion module 308 updates the gift value, and the notification module 319 sends invitations to potential contributors in accordance with aspects of the present disclosure.

The method 500 includes steps taken by the gift organizer 110 to start a social or group gift using the gifting system 300. The process begins when the gift organizer 110 visits an eCommerce website using an electronic device such as a personal computer, mobile phone, tablet, or other device, and the eCommerce website server displays the website on the electronic device of the gift organizer 110 in step 505. At the eCommerce website 320, the gift organizer 110 selects a product 510 from a product catalog 322 of the eCommerce website 320. The gift organizer 110 may select a product that she would like to either give as a gift or recommend or suggest to the gift recipient 120 as a gift that can be purchased by the gift recipient 120 using a stored value instrument that would be delivered to the gift recipient 120 in place of the product suggested by the gift organizer 110.

When the gift organizer 110 chooses the product, they may start a group gift by clicking a button or link that initiates the page analyzer 304 of the gifting system 300 in step 515. The page analyzer 304 dynamically gathers attributes regarding the product suggested by the gift organizer 110 regardless of the form and/or configuration of the eCommerce website or the platform on which it is built. Next, the page analyzer 304 automatically sends information about the product, e.g., attributes of the product, to the gifting engine 306 in step 520. Optionally, the gifting engine 306 may calculate additional fees including shipping costs, tax, and any other type of fee that may be associated with the product in step 525. The product information is converted into a gift suggestion by the gifting system 300 and is presented to the gift organizer 110 (see, e.g., page 1 of the Appendix).

The gift organizer is also presented with the option to log in to the system. The gifting system 300 receives login information of the gift organizer 110 with either a social or a non-social user ID and password in step 530. If the gift organizer 110 does not have an account and chooses to use a non-social login, the gifting system 300 displays a form to create an account on the screen of the electronic device of the gift organizer 110. Information gathered to create an account may include name, email address, and password. Upon logging in to the system, the gift organizer 110 chooses a gift recipient 120 and the system receives information of the gift recipient 120 in step 535. If the gift organizer 110 logs in with a social network, for example, FACEBOOK® or LINKEDIN®, the gift organizer 110 may be presented with a list of friends, family, or other acquaintances from which a gift recipient 120 may be selected. If the gift organizer 110 uses a non-social login to access the system, the gift organizer 110 may be presented with a form to manually input the name and email address of the gift recipient 120.

Next, the gifting system 300 presents the gift organizer 110 an option to invite others to contribute to the gift, which makes it a social or group gift, in step 540 via the screen of the electronic device of the gift organizer 110. The gift organizer 110 then sets the contribution amount, which can be more than, less than, or the same as the cost of the product they selected earlier in the process. The gifting system 300 determines whether or not the gift organizer 110 wants to invite friends in step 540. If it is determined that the organizer wants to invite contributors, the gifting system 300 receives information about the contributors from the gift organizer 110 in step 545. When the gift organizer 110 logs in with a social network, for example, FACEBOOK® or LINKEDIN®, the gift organizer 110 may be presented with a list of friends, family, or other acquaintances to select gift contributors 130 from the social network. If the gift organizer 110 uses a non-social login to access the gifting system 300, the gifting system 300 may present the gift organizer 110 with a form to manually input the name and an email address of the gift contributor 130. The gifting system then sends invitations to the contributors 130 invited by the gift organizer 110 via an email, a text message, or a posting to a homepage of each of the contributors in the social network to which the contributors belong, or via mail if the contributors are offline friends of the gift organizer 110.

The gift organizer 110 can then set the desired contribution amount and the gifting system 300 receives the desired contribution amount in step 550. In some cases, the gifting system 300 may automatically calculate the desired contribution amount based on the total cost of the gift including additional fees. Once the desired contribution amount has been set, the gift organizer 110 can personalize a gift message in step 555 by various means which include but are not limited to selecting an electronic greeting card, adding a personal message, recording a video and/or adding a photo to the gift, any and all of which will ultimately be delivered to the gift recipient 120 along with the gift. The gift organizer 110 may generate the gift message using the electronic device.

The gift organizer 110 can then set delivery options, which includes delivery date, delivery time, public or private delivery, method of delivery, for example email, SMS message, or via a social network. In step 560, the gifting system 300 receives the delivery options. In some aspects, the gift organizer 110 may be given options to choose the gift type, which may include the physical gift, a stored value instrument that can be used by the gift recipient 120 to purchase the selected gift, or both.

The next step is the payment process. The gifting system 300 receives contributions from the gift organizer 110 and the gift contributors 130 in step 565. The total amount of contributions they pay can be more than, less than, or equal to the desired contribution amount for the suggested gift. They can contribute money using any form of accepted payment which could be a credit card, PayPal, Bitcoin, or other payment mechanisms. Once a contribution is made, a payment engine of the gifting system 300 updates the total contributions in step 570 and send invites to the gift contributors 130 in step 575 if any were invited earlier in the process. The method 500 is complete in step 580 by returning a confirmation page and in some cases sending out confirmation messages via email, SMS, or social network notification.

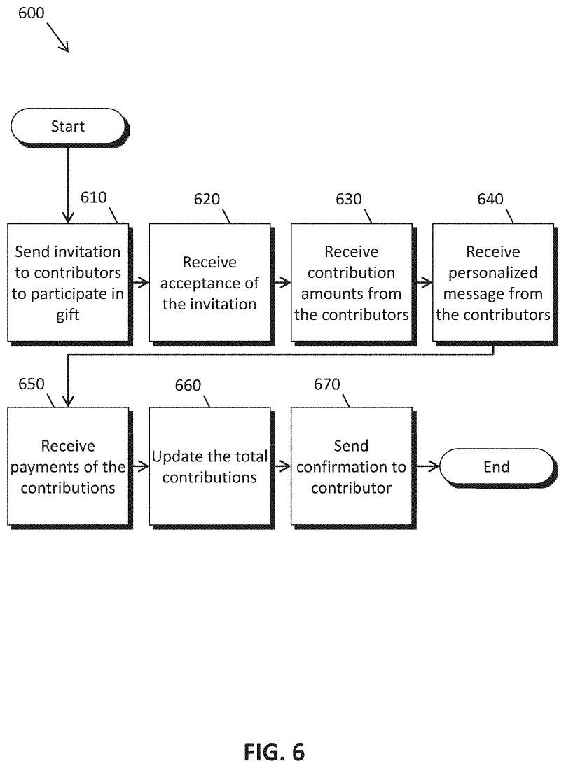

FIG. 6 is a flowchart of a method 600 illustrating how the gifting system 300 sends an invitation to a user acting as a gift contributor to participate in a gift with multiple participants, personalizes the gift, contributes to the gift and when a gifting system 300 updates the gift value in accordance with aspects of the present disclosure.

The method 600 begins when the gifting system 300 sends an invitation to an invited contributor to participate in a group gift in step 610. The invitation may be delivered to the gift contributor 130 via email, SMS, or social network notification. The invitation may contain a link to the gift which must be manually clicked to allow the gift contributor 130 to view the gift using an electronic device of the gift contributor 130. The gifting system 300 then receives the acceptance of the invitation from the invited contributor in step 620 and the invited contributor becomes a gift contributor 130. Prior to viewing the gift, the gift contributor 130 may be presented the option to log in to the system. The gift contributor 130 logs in with either a social or a non-social user ID and password. If the gift contributor 130 does not have an account and chooses to use a non-social login, they are presented with a form to create an account. Information gathered to create an account may include name, email address, and password.

Upon logging in to the gifting system 300 the gift contributor 130 can view the gift. When viewing the gift, the gift contributor 130 can see the selected product and associated stored value instrument along with a recommended contribution amount and any personalization that may be added to the gift up to the point in time while the gift is being viewed. If an invited contributor chooses to participate in the gift, a contribution may be made by either the gift contributor 130 accepting the recommended contribution amount or manually entering a contribution amount. The gifting system 300 then receives the contribution amount from the gift contributor 130 in step 630.

Next the gift contributor 130 personalizes the gift via an electronic device of the gift contributor 130 by various means which include but are not limited to selecting an electronic greeting card, adding a personal message, recording a video and/or adding a photo to the gift, any of which are delivered to the gift recipient along with the stored value instrument. The gifting system 300 receives the personalized message from the gift contributor 130 in step 640.

The next step in the process is the contributor payment 650 (which is shown, for example, on pages 26-28 of the Appendix). The amount the gift contributor 130 pays toward the gift can be more than, less than or equal to the value of the suggested contribution. They can make a payment using any form of accepted payment which could be a credit card, PayPal, Bitcoin, or any other payment mechanism. Once a contribution is made, the payment engine of the gifting system 300 will update the total contribution in step 660. The method 600 for this gift contributor 130 is complete by returning a confirmation page and in some cases sending out confirmation messages of the contribution via email, SMS, or social network notification in step 670 (which is shown, for example, on page 29 of the Appendix). The method 600 applies to all other gift contributors 130 which in some cases may not have been invited by the gift organizer 110, but which may have followed a link to the gift from a social network or which may have had an email invitation forwarded to them by an invited contributor.

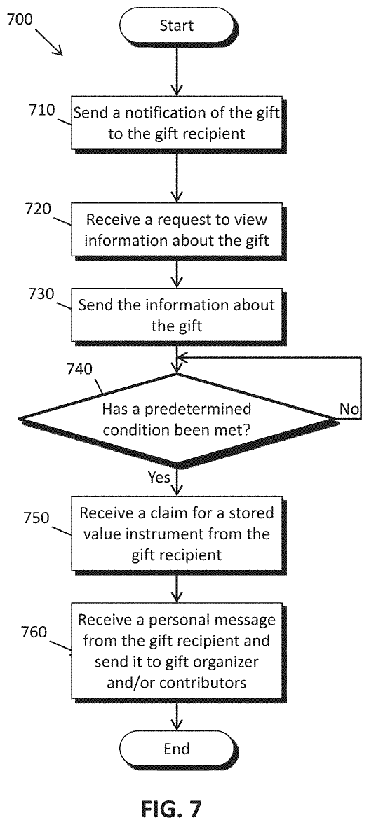

FIG. 7 is a flowchart of a method illustrating how a user acting as a gift recipient receives a gift, claims a stored value gift or is notified of a physical gift and sends a message to the gift organizer and the gift contributor 130 in accordance with aspects of the present disclosure.

The method 700 for receiving a gift begins when the gifting system 300 sends a gift notification to the gift recipient in step 710. The gift notification can be delivered to the gift recipient via email, SMS, or social network notification and the gift recipient 120 may read or view the gift notification using an electronic device. The gift notification contains a link to the gift which must be manually clicked to allow the gift recipient 120 to view the gift. When the gift recipient 120 clicks the link, the gifting system 300 receives a request to view the information of the gift from the electronic device of the gift recipient 120 in step 720.

Prior to viewing the gift, the gift recipient 120 may be presented an option to log in to the gifting system 300. The gift recipient 120 logs in with either a social or a non-social user ID and password. If the gift recipient 120 does not have an account and chooses to use a non-social login, the gifting system 300 presents the gift recipient 120 a form to create an account. Information gathered to create an account may include a name, an email address, and a password. Upon logging in to the gifting system 300, the gifting system 300 sends the information of the gift to the gift recipient 120 in step 730. Next, the recipient can view the information of the gift including the eGreeting card with all of the messages, videos, and photos from the gift organizer 110 and the gift contributors 130.

The gifting system 300 identifies the gift type or allows the gift recipient 120 to manually select one of the gift types, which may be the physical gift that was originally selected by the gift organizer 110, a stored value instrument that is delivered in place of the physical gift and can be used to purchase a physical gift, or in some cases both the physical gift and a stored value instrument.

In step 740, the gifting system 300 determines whether a predetermined condition has been met. If the predetermined condition has been met, the gift recipient can claim the stored value instrument and the gifting system 300 receives a request for the stored value instrument from the gift recipient 120 in step 750. Once the stored value instrument is claimed, the gifting system 300 communicates with the stored value processing system 334 to retrieve a gift code and presents that code to the gift recipient 120. After viewing the gift, the gift recipient can optionally send a ‘thank you’ message to the gift organizer 110 and the gift contributors 130 via email, SMS, or a social network notification. The gifting system 300 receives the ‘thank you’ message from the gift recipient 120 and sends it to the gift organizer and/or gift contributors in step 760.

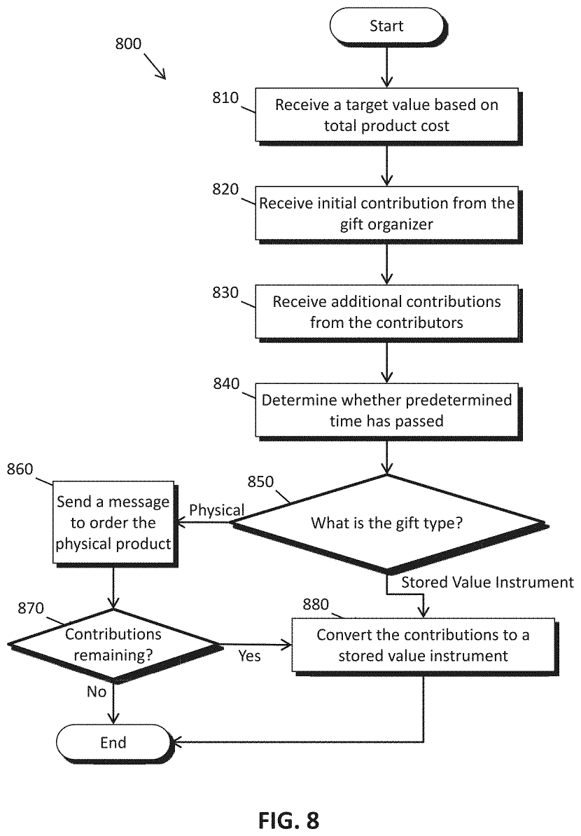

FIG. 8 is a flowchart of a gift conversion method 800 illustrating how a target value is established, value is added by multiple users, and a product or stored value instrument is delivered as a gift in accordance with another aspect of the present disclosure.

The gift conversion method 800 begins when a product is selected by a gift organizer to give as a social or group gift. The product conversion module 308 of the gifting system 300 receives the total gift costs, which could include the price of the gift plus any additional fees in order to establish target value, a total cost, or desired contribution amount in step 810. When the gifting system 300 receives the initial contribution from the gift organizer in step 820, the gifting system 300 calculates the total gift value and compares it to the target value. In some cases, this comparison may be displayed to the gift organizer 110 and/or gift recipient 120 on a screen of an electronic devices being used by the gift organizer 110 and the gift recipient 120. Each time additional contributions 830 are made, the product conversion modules 308 add them to the total gift value and compare the total gift value to the target value.

When it is determined that a predetermined time has passed in step 840, the product conversion module 308 determines the gift type and checks the business rules, and any manual configuration settings regarding how the gift will be delivered. If the gift type is a physical product, the order module 318 orders the physical product in step 860 by converting the gift value into a stored value instrument that is passed to the eCommerce website as payment for the physical product. If the gift type is a stored value instrument, the product conversion module 308 will take the gift value and convert it to a stored value instrument 880 that is delivered to the gift recipient and which is activated when claimed by the recipient.

Additionally, in some cases when a physical gift is the end gift, there may be additional value remaining on the total gift value, the product conversion module 308 will check for funds remaining 870 and when funds remain, the product conversion module 308 will convert it to a stored value instrument 880 that is delivered to the gift recipient and which is activated when claimed by the recipient. Ordering of either the physical gift or a stored value instrument will end the conversion process 890.

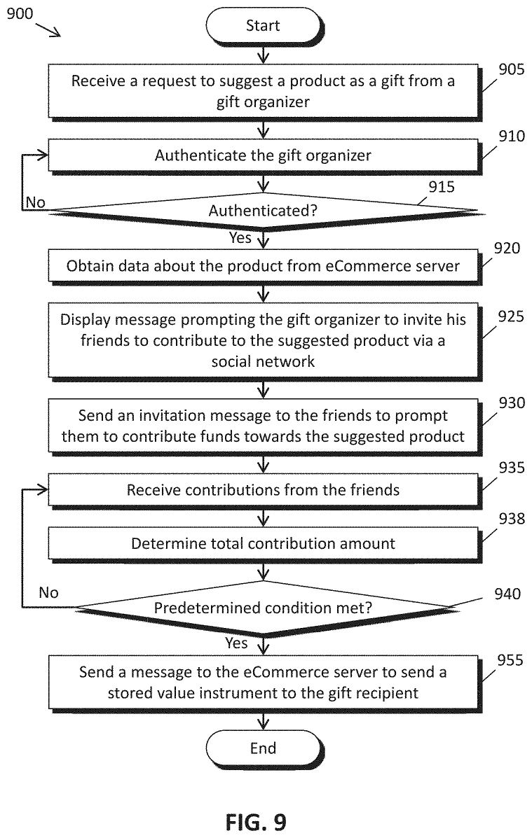

FIG. 9 illustrates a flowchart for a method 900 for electronic gifting in accordance with embodiments of the present disclosure. The gifting method of FIG. 9 provides flexibility to a gift originator, a gift recipient, and/or a gift contributor to allow for a positive gifting experience.

The gift organizer surfs eCommerce websites using an electronic device and can find a product to suggest as a gift to the gift recipient. The gift organizer may select a link located near the product. When the link is selected by the gift giver, a server running the eCommerce website is directed to send information (i.e., a request to suggest a product as a gift) related to the selected product to the gifting system server. The gifting system receives the request to suggest a product as a gift from the electronic device via the eCommerce website server in step 905. In an aspect, the information may include an address where the product is located in the eCommerce website.

For security, the gifting system server provides a login window so that the electronic device of the gift organizer displays the login window on its screen in step 910. The gift organizer inputs login information to the login window and the gifting system server authenticates the gift organizer. In an aspect, the login may be via any social network, such as FACEBOOK®, TWITTER®, LINKEDIN®, etc., or through the login process of the gifting system server. When the gift organizer desires to use the social network to login to the gifting system server, the gift organizer needs to input login information associated with the social network, which authenticates the login information.

In an aspect, when the gift organizer is not a member of the gifting system, the login windows may include a button to join the gifting system. The gift organizer may press a button and provide personal information, such as the gift organizer's name, email address, and login identification and password to become a member of the gifting system.

In step 915, the gifting system server determines whether or not the login information is correct. In a case where the gift organizer uses login information associated with the gifting system server, the gifting system server can check whether or not the login information is correct. In another case, when the gift organizer uses login information associated with the social network, a social network server, which receives the login information, determines whether the login information is correct and reports the determination result to the gifting system server, which in turn determines the correctness of the login information. When it is determined that the login information is not correct, the gifting system server continues to display the login window to the gift organizer via the electronic device. In an aspect, when the number of login tries is greater than a predetermined number, the gifting system server may prevent the gift organizer from entering login information using the same electronic device for a predetermined period.

When the login information is determined to be correct, the gifting system server obtains information about the product based on the request, which includes the address information, location information, or identification information of the product, from the eCommerce server in step 920. The obtained product information may include its price, description, and other information relating to the product, such as information in the form of videos or photos. The product information may include shipping cost, tax, an estimated time of delivery, a geographical location of the product, etc. The gifting system server pushes the product information to the electronic device of the gift organizer so that the product information can be displayed on the screen of an electronic device.

In an aspect, the gifting system server may also send options for the gift to the gift organizer via the screen of the electronic device. The options may include a desired contribution amount, a delivery date, a delivery time, and a mode of delivery. Further, the gift organizer may set a date of delivery to celebrate a special day for the gift recipient. These options provide flexibility to the gift organizer in the process of electronic gift giving.

In another aspect, the desired contribution amount may be set by the gift originator and may include the price, the tax, and the shipping and handling fees. Or the gifting system server may set a desired contribution amount to be applied towards the product based on the product information obtained from the eCommerce website server.

In step 925, the gifting system server also requests a list of friends whom the gift originator can invite to contribute to the suggested product. Upon receipt of the request from the gifting system server, the electronic device may display a form on the screen of an electronic through which the gift originator may invite friends in social networks by entering friend information into the form. The friend information may include a name, an email address, the name of a social network, and any information that may be used to identify a friend. After entering the friend information into the form displayed on the screen of the electronic device, the gift originator can click a complete or done button and the electronic device can send the friend information to the gifting system server.

In an aspect, the gift originator may invite friends outside of the social network or may invite offline friends in an offline mode. In this case, the gift originator may manually input additional information so the gifting system server can identify the offline friends. The additional information may include a name, a geographical address, and a phone number. The gifting system server may also send an email or a text message to invite the offline friends to contribute funds for a group gift.

In step 930, the gifting system server sends an invitation message to all or a portion of the friends in a social network of the gift originator. When electronic devices of each of the friends receive the invitation message, the electronic devices display the invitation message on their screens. The invitation message may be sent in the form of social network notifications and, when an invited friend clicks the social network notification, the electronic device displays the social network notification so the invited friend can read the notification. The invitation message may include a message from the gift originator, a description of a product as a gift suggestion, and a requested contribution amount. If the invited friend accepts the invitation, the invited friend becomes a gift contributor.

In an aspect, the gifting system server may allow the gift originator and the gift contributors to send personalized messages from their electronic devices to the gift recipient. To this end, the gifting system server may display a screen or series of screens allowing the gift originator and the gift contributors to create and send a video message, a photo message, an audio message, or a text message.

The gift originator and/or the gift contributors can electronically send their contributions to the gifting system server via a credit card, a debit card, a gift card, a coupon, wire transfer, wireless transfer, or any other method known to those skilled in the art. Whenever a contribution is received in step 935, the gifting system server may update a total contribution amount in step 938. In an aspect, the gifting system server may graphically show the total contribution amount in comparison to the target amount, from example, through the use of a progress bar.

In step 940, the gifting system server determines whether a predetermined condition is met. The predetermined condition may be met when a date and time set by the gift originator has been reached, when the total contribution amount exceeds the desired contribution amount, or when all the gift contributors have made contributions. The predetermined condition may be preset by the gift originator or the gifting system server.

If the predetermined condition has not been met, the process returns to step 935. Otherwise, if the predetermined condition has been met, the gifting system server sends a control message to the eCommerce website server to purchase and send a stored value instrument and information regarding the suggested product to the gift recipient in step 955.

In one aspect, the gifting system server may send a notification message to the gift recipient via an electronic device associated with the gift recipient. The notification message may include the gift, personalized messages, delivery information, and any other relevant information about the suggested gift, the gift originator, and the gift contributors.

The appendix to the specification illustrates various example screens of a user interface for the gifting of stored value instruments according to aspects of the present disclosure.

Since other modifications and changes may be made to fit particular operating requirements and environments, it is to be understood by one skilled in the art that the present disclosure is not limited to the examples described in the present disclosure and may cover various other changes and modifications which do not depart from the spirit or scope of this disclosure.

What is claimed is:

1. A method for electronically providing a stored value instrument in place of a suggested product as a gift, the method comprising:
receiving from at least a first electronic device associated with a first user a request to suggest a product, which is defined by data stored in an eCommerce server, as a gift for a second user associated with at least a second electronic device;
obtaining data of the product from the eCommerce server;
authenticating the first user of the at least the first electronic device;
determining a contribution amount;
receiving funds from the first user to be applied towards the contribution amount;
determining whether a predetermined condition has been met; and
sending a message to the second user including the data of the product suggested as a gift to the second user and a stored value instrument to the second user, if the predetermined condition has been met.

2. The method according to claim 1, further comprising:
displaying a screen on the at least the first electronic device prompting the first user to invite at least a third user associated with at least a third electronic device to contribute towards the cost of the product;
sending an invitation message to the at least the third electronic device, the invitation message including a link to view the product, a setting of the contribution amount, and a personalized message field; and
receiving funds from the at least a third user to be applied towards the contribution amount.

3. The method according to claim 2, wherein the invitation message is sent to the at least a third user via a social network, an email, or an SMS message.

4. The method according to claim 1, further comprising
prompting the first user to manually set a contribution amount
or automatically calculating contribution amounts.

5. The method according to claim 4, wherein the stored value instrument is selected from a group consisting of a gift card, a gift certificate, a store credit, an online credit, an offline credit, a coupon, and any combinations thereof.

6. The method according to claim 1, further comprising:
receiving a claim for the stored value instrument from the at least a second electronic device associated with a second user; and
receiving a message from the at least a second electronic device to be provided to at least the first user.

7. The method according to claim 6, wherein determining whether the predetermined condition is met includes at least one of determining whether a predetermined period has elapsed and determining whether a total contribution amount is greater than or equal to a target contribution amount.

8. The method according to claim 6, wherein the at least a third user includes a plurality of users, and
wherein determining whether a predetermined condition is met includes determining whether the first user and the plurality of users have all contributed funds towards the contribution amount.

9. The method according to claim 1, further comprising:
determining a gift type;
converting the contributed funds to a stored value instrument if it is determined that the gift type is a stored value instrument; and
sending a message to order the product if it is determined that the gift type is a physical product.

10. The method according to claim 1, further comprising:
determining whether a total contribution amount is greater than the cost of the product to determine whether there are additional funds; and
converting the additional funds to a stored value instrument if it is determined that the total contribution amount is greater than the cost of the product.

11. The method according to claim 1, wherein the obtained data regarding the product is selected from the group consisting of a price, a tax, a shipping cost, a description, an image of the product, and any combinations thereof.

12. The method according to claim 1, wherein obtaining data of the product from the eCommerce server includes dynamically analyzing a webpage of the eCommerce server to obtain data regarding the product.

13. A gifting system for electronically providing a stored value instrument in place of a suggested product as a gift, the system comprising:
a processor; and
a memory storing processor-executable instructions that, when executed by the processor, cause the gifting system to:
receive from at least a first electronic device associated with a first user a request to suggest a product, which is defined by data stored in an eCommerce server, as a gift for a second user associated with at least a second electronic device;
obtain data of the product from the eCommerce server;
authenticate the first user of the at least the first electronic device;
determine a contribution amount;
receive funds from the first user to be applied towards the contribution amount;
determine whether a predetermined condition has been met; and
send a message to the second user including the data of the product suggested as a gift to the second user and a stored value instrument to the second user, if the predetermined condition has been met.

14. The gifting system according to claim 13, wherein the memory further stores processor-executable instructions that, when executed by the processor, cause the gifting system to:
display a screen on the at least the first electronic device prompting the first user to invite at least a third user associated with at least a third electronic device to contribute towards the cost of the product; and
send an invitation message to the at least the third electronic device, the invitation message including a link to view the product, a setting of the contribution amount, and a personalized message field; and
receive funds from the at least a third user to be applied towards the contribution amount.

15. The gifting system according to claim 14, wherein the invitation message is sent to the at least a third user via a social network, an email, or an SMS message.

16. The gifting system according to claim 13, wherein the memory further stores processor-executable instructions that, when executed by the processor, cause the gifting system to prompt the first user to manually set a contribution amount or automatically calculate contribution amounts.

17. The gifting system according to claim 16, wherein the stored value instrument is selected from a group consisting of a gift card, a gift certificate, a store credit, an online credit, an offline credit, a coupon, and any combinations thereof.

18. The gifting system according to claim 13, wherein the memory further stores processor-executable instructions that, when executed by the processor, cause the gifting system to:
receive a claim for the stored value instrument from the at least a second electronic device associated with a second user; and
receive a message from the at least a second electronic device to be provided to at least the first user.

19. The gifting system according to claim 18, wherein the predetermined condition is met when a predetermined period has elapsed and when a total contribution amount is greater than or equal to a target contribution amount.

20. The gifting system according to claim 18, wherein the at least a third user includes a plurality of users, and
wherein the predetermined condition is met when the first user and the plurality of users have all contributed funds towards the contribution amount.

21. The gifting system according to claim 13, wherein the obtained data regarding the product is selected from the group consisting of a price, a tax, a shipping cost, a description, an image of the product, and any combinations thereof.

22. The gifting system according to claim 13, wherein the memory stores further instructions that, when executed by the processor to dynamically analyze a webpage of the eCommerce server to obtain data regarding the product.

23. A system comprising:
a page analyzer configured to gather attributes about a product selected by an organizer as a gift from an eCommerce website server; and
a gifting engine configured to create a screen to present the selected product as a suggested gift based on the product attributes gathered by the page analyzer, and to convert the selected product to a stored value instrument when a predetermined condition is met.

24. The system according to claim 23, further comprising an interface coupled to the gifting engine, wherein the interface retrieves data about the product from a plurality of external data sources and transfers the data about the product to the gifting engine,
wherein the gifting engine creates the screen presenting the selected product as a suggested gift based on the data about the product.
